(19) United States
(12) Patent Application Publication
(10) Pub. No.: US 2013/0306220 A1
(43) Pub. Date: Nov. 21, 2013

(54) PRODUCTION AND REPAIR OF FIBRE REINFORCEED COMPOSITE COMPONENTS WITH ENHANCED SURFACE AND ADHESION PROPERTIES

(71) Applicant: Neil Deryck Bray Graham, Coogee (AU)

(72) Inventor: Neil Deryck Bray Graham, Coogee (AU)

(73) Assignee: Quickstep Technologies Pty Ltd., North Coogee (AU)

(21) Appl. No.: 13/992,509

(22) PCT Filed: Dec. 7, 2011
(86) PCT No.: PCT/AU11/01577

§ 371 Date: Aug. 7, 2013

(30) Foreign Application Priority Data
Dec. 9, 2010 (AU) 2010905414

(51) Int. Cl. B32B 37/04

(52) U.S. Cl. CPC B32B 37/04
USPC 156/73.6; 156/309.6; 156/94

(57) ABSTRACT

A method of joining a fibre reinforced laminate layer to a surface (3), including applying a layer of melted resin on to the surface (3), the resin displacing air from the surface and solidifying upon cooling on the surface to thereby form a layer of solidifled resin (7) thereon, applying a composite lay-up (13) over the resultant layer of solidified resin, and heating and melting the resin so that the composite lay-up is submerged in the melted resin and the resin is subsequently cured to thereby form the laminate layer (19).

### FIELD OF THE INVENTION

The present invention is directed to the production and repair of composite components formed from thermo curing or thermo setting resin reinforced with fibre such as fibreglass and carbon fibre.

### BACKGROUND TO THE INVENTION

Metal faced tooling is used to provide a mould for forming composite components such as aerospace and automotive parts eg. car bonnets and other car panels. Such metal faced tooling typically comprises a thin sprayed or electoformed metal surface layer supported by a carbon fibre reinforced backing. A problem relating to such tooling is that any damage to the metal layer will render the tooling useless. It is unfortunately relatively easily to chip the metal layer away from the carbon fibre backing. This is because the adhesion between the thin metal layer and the supporting carbon fibre composite backing is relatively weak as it is primarily facilitated by the laminating resin, which is brittle. Adhesives and pastes have been tried but this results in the fracture point moving out to the interface with the laminate. It improves the adhesion performance but does not eliminate the problem. It would be advantageous to be able to improve the adhesion of the metal layer to the carbon composite backing directly at the surface as this will remove the interface and discontinuity problem and help to extend the life of the metal faced tooling in terms of the surface finish and vacuum integrity. This approach would be suitable for many products where surface adhesion would enhance surface performance and thus product performance in the field.

Problems with adhesion also arise in other areas and in particular in the repair of damaged fibre reinforced composite panels, particularly in aerospace composite structures. The usual method for repairing such composite panels is to apply a patch in the form of a resin impregnated cloth over the damaged area of the component, and to subject the patch to elevated pressure and temperature to both cure and adhere the patch to the damaged area. The typical method used to increase the adhesion of the patch to the damaged area is to roughen the area surrounding the damaged area and chamfer the area back so as to produce a smoothly formed ramp exposing each layer of the laminate for the thickness of the laminate to provide a gradual load transfer and to thereby provide a better mechanical joint for the patch. A primer or surface treatment is placed onto the chamfered surface and the patch added on top. The problem with such a mechanical joint is that it is almost impossible to have a perfect wet out of the surface and air is trapped between the surface and the patch. Moisture can then be absorbed through the laminate and seep into and run along the joint on the interface/surface which can result in disbonding of the patch. It would therefore be preferable to be able to improve the adhesion of the patch first by improving the adhesion on the chamfer or to save significant time by having a much smaller chamfer area to transfer the load. This may be possible if the adhesion is improved significantly.

It is therefore an object of the present invention to provide a method of improving the adhesion of a fibre reinforced layer with an adjacent surface.

With this in mind, the present invention provides a method of joining a fibre reinforced laminate layer to a surface, including applying a layer of melted resin on to the surface, the resin displacing air from the surface and solidifying upon cooling on the surface to thereby form a layer of solidified resin thereon, applying a composite lay-up over the resultant layer of solidified resin, and heating and melting the resin so that the composite lay-up is submerged in the melted resin and the resin is subsequently cured to thereby form the laminate layer.

Displacement of the air away from the surface helps to ensure that little to no air pockets remain at the interface between the surface and the laminate layer thereby improving the adhesion therebetween. Submerging the composite lay-up into the melted resin also assists in driving out any remaining air entrained within the composite lay-up. The formed laminate layer may therefore be continuous without inconsistencies.

The adhesion may be further improved according to the present invention by also applying nanoparticles together with the melted resin, wherein a substantial portion of the nanoparticles contained within the resin are driven towards and concentrated at and adjacent the surface.

The nanoparticles may be premixed with the resin applied to the surface. Alternatively, the resin may be initially applied to the surface, and the nanoparticles subsequently distributed through the resin whilst in a liquid state. Vibration means may be used to further distribute the nanoparticles through the resin and therefore concentrate it onto or close to the surface.

The amount of nanoparticles added to the resin may preferably be less than 2% by weight to the resin. The addition of greater amounts of nanoparticles will result in the resin acting more like a paste than a liquid. This will make it more difficult to apply the resin layer to the surface while avoiding air being trapped between the resin “paste” and the surface. The application of the resin mixed with a low concentration of nanoparticles enables it to be moved, sprayed and deposited in layers onto the surface. Subsequently submerging the composite lay-up into the resin acts to filter and separate the resin from the nanoparticles which are driven, towards and concentrated near, the surface at the interface between the resin layer and the surface. This concentration of the nano particles on or near the surface is the equivalent to the paste but without the difficulties of applying the paste and without the discontinuities. The laminate layer may therefore be continuous all the way from the surface being bonded to, right out to the outer surface of the laminate layer. In this way, a void free laminate without any inconsistencies between joints and layers is formed that has high strength and shock resistance.

The composite lay-up, also known as a “pre pack”, may be formed from one or more fibre bundle layers. The composite lay-up may further include at least one nanoparticles control layer for assisting in the driving of the nanoparticles towards the surface as the composite lay-up submerges into the melted resin layer. The nanoparticles control layer may for example be in the form of a para-aramid synthetic fibre known as “Kevlar” (registered trade mark of DuPont) veil or other form of control mechanism forming part of the composite lay-up.

The surface may be provided by an inner face of a metal layer of a metal faced tooling mould. Alternatively, the surface may be that of a damaged fibre reinforced composite panel. The present invention is however not limited to these applications, and other applications requiring improved adhesion are also envisaged.

The melted resin may preferably be applied to the surface through a spraying process, the advantage of applying the resin to the surface is that it minimises or eliminates the formation of air pockets immediately adjacent the surface. The resin may be supplied in powder form for the spraying process. During the spraying process, the powdered resin is melted and is splattered over the surface to drive away any air entrained against the surface and to thereby form the resultant resin layer over the surface. It is however also envisaged that the resin may be applied by pumping with an applicator pad, or roller or manually by brush or other means.

Heat and pressure may be applied to the composite lay-up and the resin layer to melt and subsequently cure the resin using known methods. For example, in the applicant's Australian Patent Nos. 697678, 2001237133 and 2002227779, there is described an apparatus using a pressure chamber having a displaceable abutment face where fluid at elevated pressure and temperature is circulated through the pressure chamber to effect the compaction and curing of a composite lay-up patch.

While the surfaces to which the present invention can be applied may appear smooth after sanding and grinding, such surfaces are in fact very rough at the nanoscale. Therefore, the provision of nanoparticles driven down and concentrated onto the interface between the resin and the surface acts to key in and thereby engage the surface such that the effective adhesion between the surface and the resin is improved. It is estimated that a tenfold increase in adhesion may be achieved due to the improvement in the shear strength between the laminate layer and the surface.

Nanoparticles can be formed from a variety of different materials including carbon, silicon, metal, or other dielectric and semiconductor materials. The term “nanoparticles” also encompass particles that are not in the nano scale such as spicules which are small glass microfibres or diamond dust. Carbon is commonly used to form graphene or elongate nanotubes. Such graphene or carbon nanotubes can also potentially improve the heat transfer rate between the surface and adjacent laminate layer because of the relatively high thermal conductivity of graphene and carbon nanotubes. The addition of diamond dust can also improve the heat transfer properties.

### BRIEF DESCRIPTION OF THE DRAWINGS

It will be convenient to further describe the invention with respect to the accompanying drawings which illustrate a preferred embodiment of the method according to the present invention. Other embodiments of the invention are possible, and consequently, the particularity of the accompanying drawings is not to be understood as superseding the generality of the preceding description of the invention.

In the drawings:

FIG. 1 is a schematic partial side cross-sectional view of a mould and a resin layer according to a first step of the present invention;

FIG. 2 is a schematic partial side cross-sectional view of the mould and resin layer of FIG. 1 showing a subsequent step of the present invention; and

FIG. 3 is a schematic partial side cross-sectional view of a mould and final laminate layer showing a final step of the present invention.

### DETAILED DESCRIPTION OF THE INVENTION

The Figures illustrate the various steps of the method of joining a fibre reinforced laminate layer to a surface according to the present invention. The invention will be described with reference to its application in the manufacture of metal faced tooling moulding, although the present invention is equally applicable in the repair of fibre reinforced composite panels or in other applications.

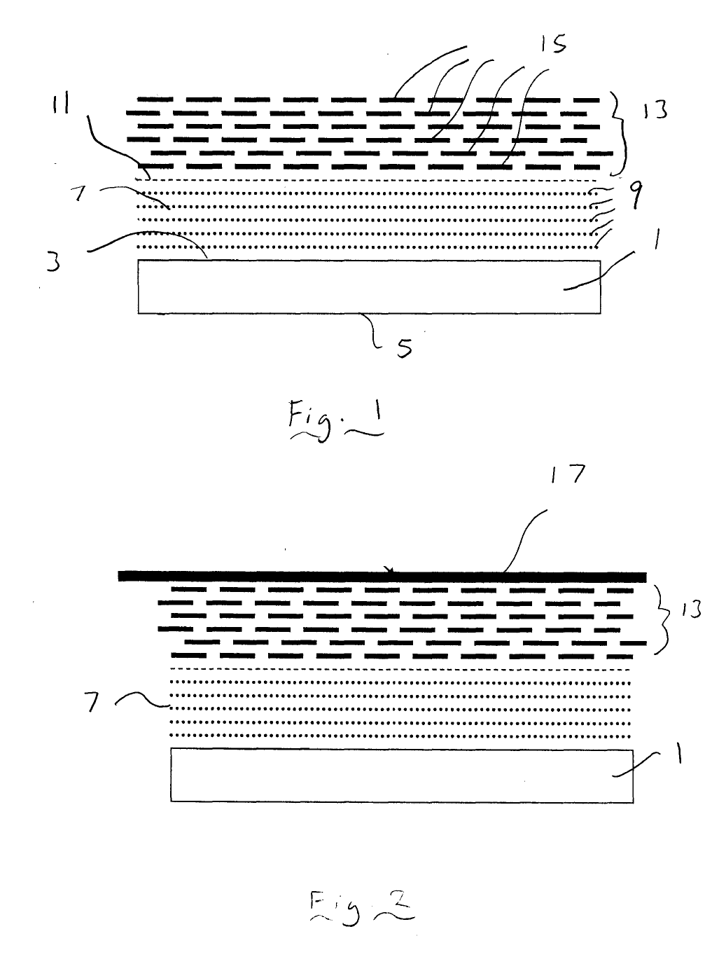

Referring initially to FIG. 1, there is shown a metal layer 1 of a metal faced tooling mould. The metal layer 1 has an outer surface 5 for providing the mould surface. The metal layer 1 also has an inner surface 3 which needs to be adhered to a carbon fibre reinforced laminate layer in the final finished mould.

The preliminary step of the present invention involves the application of a layer of resin over the inner surface 3. The resin may be applied using a spraying arrangement as this assists in ensuring that little to no air bubbles are formed at the interface between the mould inner surface 3 and the resin layer 7. A variety of different resins can be used to form the resin layer 7, the primary criteria being that the resin is normally solid at room temperature and may be melted into a liquid phase without the resin curing so that it can be applied to the surface 3. Therefore, after the resin has been applied to the inner surface 3, the resin solidifies into the resin layer 7. Nanoparticles 9 (schematically shown by the dotted lines) are distributed through the resin layer 7. The nanoparticles 9 can be premixed with the melted resin prior to application to the surface 3. Alternatively, the nanoparticles 9 may be distributed over the resin layer 7 when still in a liquid state. Vibration means (not shown) may also be used to assist in redistributing the nanoparticles 9 throughout the resin layer 7.

Once the resin layer 7 has solidified, a nanoparticles control layer 11 may be laid over the resin layer 7. The function of this control layer 11 will be subsequently described. A composite lay-up 13, also known as a “pre pack”, is then laid over the control layer 11. This pre pack 13 can be formed by one or more fibre bundle layers 15. These fibre bundle layers 15 may be held together by applying a small or a greater amount of resin to complete the wetting out of the laminate but not so much as to stop the resin/airflow through the laminate. The objective of this amount of melted resin between the layers 15, once solidified, is to hold the pre pack 13 together and wetout the laminate fully once melted.

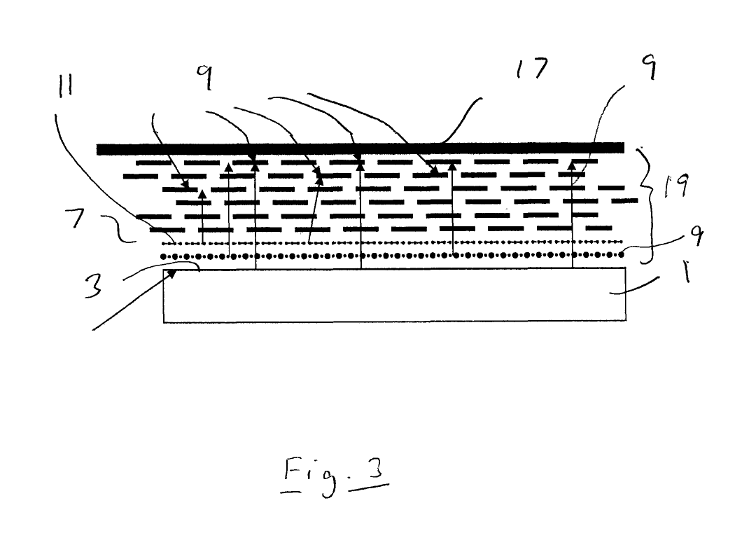

In the next step according to the present invention as shown in FIG. 2, a vacuum bag 17 is laid over the pre pack 13 and the air is extracted from under the vacuum bag 17 to compact and draw most of the air out of the pre pack 13.

FIG. 3 shows the next step of the present invention where heat and pressure is applied to the resin layer 7 and pre pack 13. The applicant has developed various methods and apparatus for the production and repair of fibre reinforced composite components as for example shown in Australian Patent Nos. 697678, 2001237133 and 2002227779. The use of other more conventional methods for applying pressure and heat to the pre pack 13 and resin layer 7 are also envisaged.

Referring to FIG. 3, as heat is applied to the resin layer 7, the resin melts and the pre pack 13 is forced down into and is submerged within the now melted resin layer 7. The nanoparticles control layer 11 is also forced down towards the inner surface 3 of the mould. This control layer 7 acts to “filter” the nanoparticles 9 from the melted resin such that the nanoparticles 9 are concentrated at the interface between the inner surface 3 and the resin 7. Some of the nanoparticles 9 may pass through the control layer 7 and move through the pre pack 13. These nanoparticles 9 will assist in providing reinforcement for the final fibre reinforced laminate layer 19 in a direction generally lateral to the inner face 3. The majority of the nanoparticles 9 will however be concentrated in the area adjacent the surface 3. It is also envisaged that no nanoparticle control layer 11 be used, the pre pack 13 itself instead acting to drive the nanoparticles onto the surface. The heat applied to the resin at this stage fully cures the resin to thereby form the final fibre reinforced laminate layer 19.

The concentration of nanoparticles 9 adjacent the inner surface 3 acts to anchor the now cured fibre reinforced composite layer to the inner surface 3 thereby providing improved adhesion of the final fibre composite laminate layer 19 to the metal layer 1.

In addition, the nanoparticles 9 also act to improve the heat transfer between the inner surface 3 and the adjacent laminate layer 19, particularly when graphene or carbon nanotubes, which have a very high thermal conductivity, is used.

Modifications and variations as would be deemed obvious to the person skilled in the art are included within the ambit of the present invention as claimed in the appended claims.

1-11. (canceled)

12. A method of joining a fibre reinforced laminate layer to a surface, including applying a layer of melted resin on to the surface, the resin displacing air from the surface and solidifying upon cooling on the surface to thereby form a layer of solidified resin thereon, applying nanoparticles together with the melted resin, applying a composite lay-up over the resultant layer of solidified resin, and heating and melting the resin so that the composite lay-up is submerged in the melted resin and the resin is subsequently cured to thereby form the laminate layer, wherein at least a substantial portion of the nanoparticles contained within the resin are driven towards and concentrated at and adjacent the surface.

13. A method according to claim 12, wherein the nanoparticles are premixed with the resin prior to application.

14. A method according to claim 12, including applying the nanoparticles on the resin layer following application thereof.

15. A method according to claim 13 including vibrating the resin while melted to facilitate distribution of the nanoparticles therethrough.

16. A method according to claim 14 including vibrating the resin while melted to facilitate distribution of the nanoparticles therethrough.

17. A method according to claim 12 wherein the resin is sprayed onto the surface.

18. A method according to claim 12 further including at least one nanoparticles control layer with the composite lay-up to assist in the driving of the nanoparticles towards the surface.

19. A method according to claim 17, wherein the nanoparticles control layer is a para-aramid synthetic fibre veil.

20. A method according to claim 12 wherein less than 2% by weight of nanoparticles are added to the resin.

21. A method according to claim 12, wherein the surface is an inner surface of a metal layer of a metal faced tooling mould.

22. A method according to claim 12, wherein the surface is a damaged surface of a fibre reinforced composite panel.

23. A method according to claim 13 wherein the resin is sprayed onto the surface.

24. A method according to claim 14 wherein the resin is sprayed onto the surface.

25. A method according to claim 15 wherein the resin is sprayed onto the surface.

26. A method according to claim 16 wherein the resin is sprayed onto the surface.

27. A method according to claim 13 further including at least one nanoparticles control layer with the composite lay-up to assist in the driving of the nanoparticles towards the surface.

28. A method according to claim 14 further including at least one nanoparticles control layer with the composite lay-up to assist in the driving of the nanoparticles towards the surface.

29. A method according to claim 15 further including at least one nanoparticles control layer with the composite lay-up to assist in the driving of the nanoparticles towards the surface.

30. A method according to claim 16 further including at least one nanoparticles control layer with the composite lay-up to assist in the driving of the nanoparticles towards the surface.

31. A method according to claim 17 further including at least one nanoparticles control layer with the composite lay-up to assist in the driving of the nanoparticles towards the surface.
